(19) United States
(12) Patent Application Publication
(10) Pub. No.: US 2025/0321340 A1
(43) Pub. Date: Oct. 16, 2025

(54) ELECTRONIC DEVICE

(71) Applicant: InnoCare Optoelectronics Corporation, Tainan City (TW)

(72) Inventor: Chih-Hao Wu, Tainan City (TW)

(73) Assignee: InnoCare Optoelectronics Corporation, Tainan City (TW)

(21) Appl. No.: 19/001,409

(22) Filed: Dec. 25, 2024

(30) Foreign Application Priority Data
Apr. 16, 2024 (TW) 113114093

(51) Int. Cl. G01T 1/20

(52) U.S. Cl. CPC G01T 1/2018

(57) ABSTRACT

An electronic device includes a sensor, a scintillator layer, and a wavelength conversion layer. The scintillator layer is disposed on the sensor. The wavelength conversion layer is disposed between the scintillator layer and the sensor.

### CROSS-REFERENCE TO RELATED APPLICATION

This application claims the priority benefit of Taiwan application serial no. 113114093, filed on Apr. 16, 2024. The entirety of the above-mentioned patent application is hereby incorporated by reference herein and made a part of this specification.

### BACKGROUND

### Technical Field

The disclosure relates to an electronic device.

### Description of Related Art

The X-ray detection device may convert an X-ray into visible light using a scintillator layer and receive the visible light using a sensor for subsequent image processing. If the emission spectrum peak of the scintillator layer does not match the absorption response spectrum peak of the sensor, the light conversion efficiency of the sensor will be poor.

### SUMMARY

The disclosure provides an electronic device that helps improve the light conversion efficiency of a sensor.

In an embodiment of the disclosure, an electronic device includes a sensor, a scintillator layer, and a wavelength conversion layer. The scintillator layer is disposed on the sensor. The wavelength conversion layer is disposed between the scintillator layer and the sensor.

In order to make the above-mentioned features and advantages of the disclosure clearer and easier to understand, the following embodiments are given and described in details with accompanying drawings as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1, FIG. 3, FIG. 4, FIG. 5, FIG. 6, FIG. 7, FIG. 8, FIG. 9, and FIG. 10 are respectively partial schematic cross-sectional diagrams of an electronic device according to some embodiments of the disclosure.

FIG. 2 is a schematic diagram of an emission spectrum of a scintillator layer, an emission spectrum of a wavelength conversion layer, and an absorption response spectrum of a sensor.

### DESCRIPTION OF THE EMBODIMENTS

Reference will now be made in detail to the exemplary embodiments of the present disclosure, examples of which are illustrated in the accompanying drawings. Whenever possible, the same reference numbers are used in the drawings and descriptions to refer to the same or like parts.

Certain terms are adopted throughout the specification and claims of this disclosure to refer to specific components. Those skilled in the art should understand that manufacturers of electronic devices may refer to the same element with different names. This document does not intend to distinguish between those elements that have the same function but have different names. In the following specification and claims, words such as “comprising” and “including” are open-ended words, so they should be interpreted as meaning “including but not limited to . . . ”.

The directional terms mentioned herein, such as “up”, “down”, “front”, “rear”, “left”, “right”, etc., are only referring to the directions of the accompanying drawings. Accordingly, the directional terms used are for illustration, not for limitation of the present disclosure. In the drawings, each figure illustrates the general characteristics of methods, structures, and/or materials used in particular embodiments. However, these drawings should not be interpreted as defining or limiting the scope or nature encompassed by these embodiments. For example, the relative sizes, thicknesses and positions of layers, regions and/or structures may be reduced or exaggerated for clarity.

A structure (or layer, element, substrate) described in this disclosure being located on/above another structure (or layer, element, substrate) may mean that the two structures are adjacent to each other and directly connected, or mean that the two structures are adjacent to each other rather than directly connected. Indirect connection means that there is at least one intermediate structure (or intermediate layer, intermediate element, intermediate substrate, intermediate spacer) between two structures, a lower surface of one structure is adjacent to or directly connected to an upper surface of the intermediate structure, and the upper surface of another structure is adjacent to or directly connected to the lower surface of the intermediate structure. The intermediate structure may be composed of a single-layer or multi-layer physical structure or a non-physical structure, the disclosure provides no limitation thereto. In this disclosure, when a certain structure is set “on” other structures, it may mean that a certain structure is “directly” on other structures, or that a certain structure is “indirectly” on other structures, that is, there is at least one structure interposed between the certain structure and other structures.

The terms “about”, “equal to”, “equivalent to” or “the same as”, “substantially”, or “approximately” used in the text are generally interpreted as being within 20% of a given value or range, or interpreted as being within 10%, 5%, 3%, 2%, 1%, or 0.5% of a given value or range. In addition, the terms “the range is from the first value to the second value” and “the range is between the first value and the second value” indicate that the range includes the first value, the second value and other values therebetween.

Ordinal numbers such as “first”, “second” and the like used in the description and claims of the disclosure are used to modify elements, which do not imply and represent that the (or these) elements are numbered in sequence, or represent the order of a certain element and another element, or the order of the manufacturing method. The use of these ordinal numbers is only used to clearly distinguish the element with a certain name from another element with the same name. The same wording may not be used in claims of the disclosure and the specification. Accordingly, the first component in the specification may be the second component in claims of the disclosure.

In some embodiments of the disclosure, regarding the words such as “connected”, “interconnected”, etc. referring to bonding and connection, unless specifically defined, these words mean that two structures are in direct contact or two structures are not in direct contact, and other structures are provided to be disposed between the two structures. The word for joining and connecting may also include the case where both structures are movable or both structures are fixed. In addition, the term “coupled” may include any direct or indirect electrical connection means. In addition, the term “connected” includes a means of signal communication by which two elements or devices can directly or indirectly receive and/or transmit wireless signals.

The electrical connection or coupling described in this disclosure may refer to direct connection or indirect connection. In the case of direct connection, the terminals of the components on the two circuits are directly connected or connected to each other with a conductor line segment. In the case of indirect connection, there are switches, diodes, capacitors, inductors, resistors, other suitable components, or combinations of the above components between the terminals of the components on the two circuits, but not limited thereto.

In this disclosure, the thickness, length and width may be measured by optical microscope (OM), and the thickness or width may be obtained by measuring the cross-sectional image in the electron microscope, but not limited thereto. In addition, any two values or directions used for comparison may have certain errors. Moreover, the phrase “a given range is a first value to a second value”, “a given range falls within a range of a first value to a second value” or “a given range is between a first value and a second value” means that the given range includes the first value, the second value and other values therebetween. If the first direction is perpendicular to the second direction, the angle between the first direction and the second direction may be between 80 degrees and 100 degrees; if the first direction is parallel to the second direction, the angle between the first direction and the second direction may be between 0 degrees and 10 degrees.

It should be noted that, in the following embodiments, without departing from the spirit of the present disclosure, the features in several different embodiments can be replaced, reorganized, and mixed to complete other embodiments. As long as the features of the various embodiments do not violate the spirit of the disclosure or conflict with each other, they may be mixed and matched freely.

Unless otherwise defined, all terms (including technical and scientific terms) used herein have the same meaning as commonly understood by those skilled in the art. It can be understood that these terms, such as those defined in commonly used dictionaries, should be interpreted as having meanings consistent with the background or context of the related technology and the present disclosure, and should not be interpreted in an idealized or overly formal manner, unless otherwise defined in the disclosed embodiments.

The type and the form of an electronic device are not limited. For example, the electronic device may include a display device, a backlight device, an antenna device, a detection device, a splicing device, or any device that requires charging. In addition, the electronic device may be a bendable or flexible electronic device.

The display device may be a non-self-luminous display device or a self-luminous display device. The display device may include, for example, liquid crystal, a light emitting diode, fluorescence, phosphor, a quantum dot (QD), other suitable display media, or a combination of the above. The antenna device may be a liquid crystal type antenna device or a non-liquid crystal type antenna device, and the detection device may be a detection device for sensing capacitance, light rays (for example, visible light or X-rays), thermal energy, or ultrasonic waves, but not limited thereto. In some embodiments, the electronic device may include an electronic component. The electronic component may include a passive element and an active element, such as a capacitor, a resistor, an inductor, a diode, and a transistor. The diode may include a light emitting diode or a photodiode. The light emitting diode may include, for example, an organic light emitting diode (OLED), a mini LED, a micro LED, or a quantum dot LED, but not limited thereto. The splicing device may be, for example, a display splicing device, a detection splicing device, or an antenna splicing device, but not limited thereto. It should be noted that the electronic device may be any permutation and combination of the above, but not limited thereto. In addition, the shape of the electronic device may be rectangular, circular, polygonal, a shape with curved edges, or other suitable shapes. The electronic device may have a peripheral system such as a driving system, a control system, and a light source system to support the display device, the antenna device, a wearable device (for example, including augmented reality or virtual reality), a vehicle-mounted device (for example, including a car windshield), the splicing device, etc.

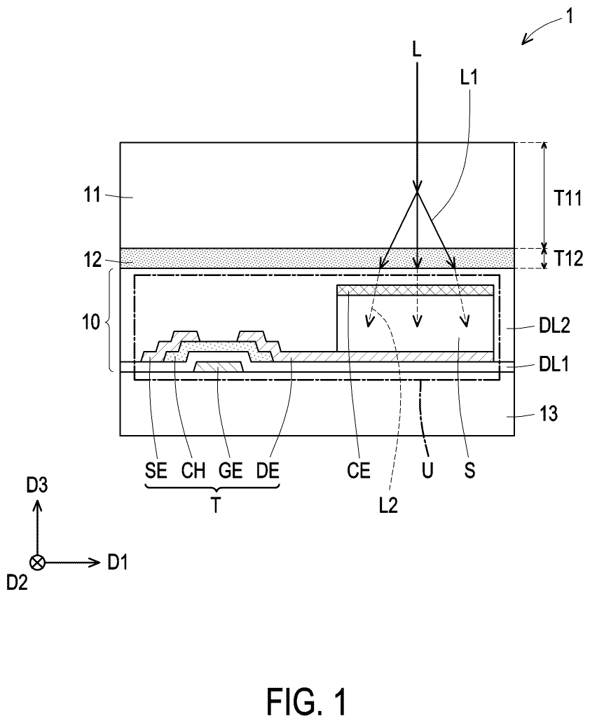

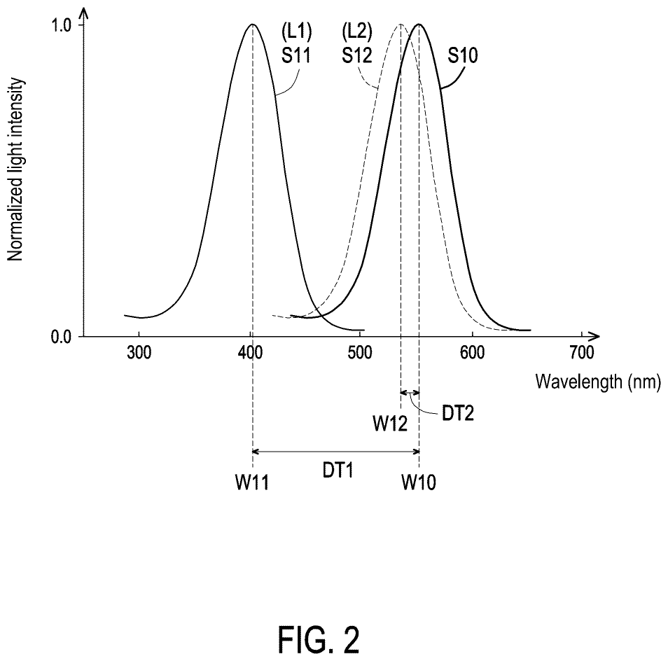

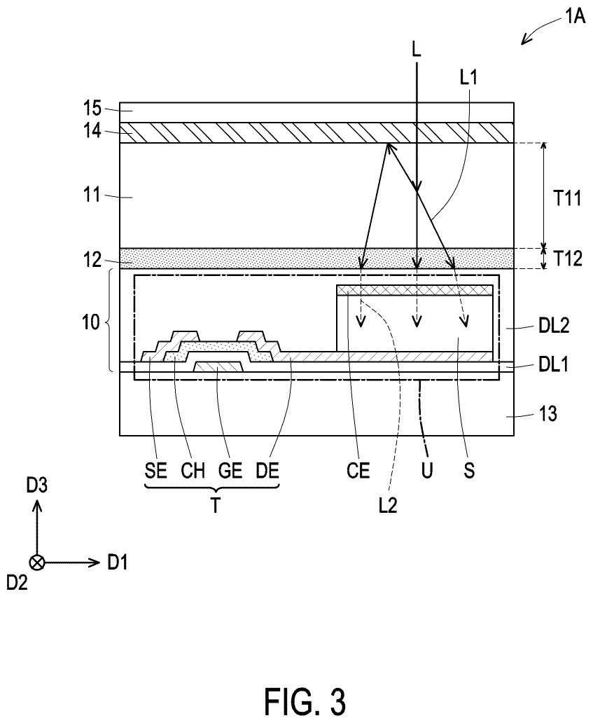

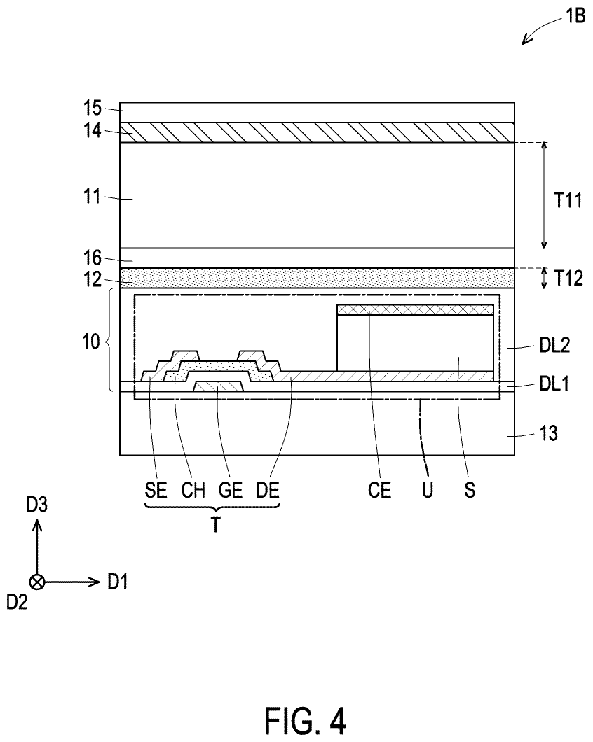

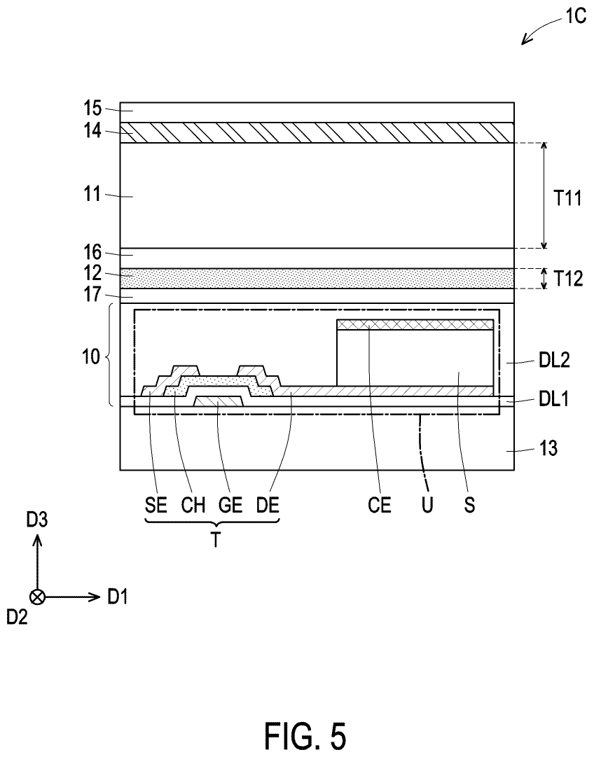

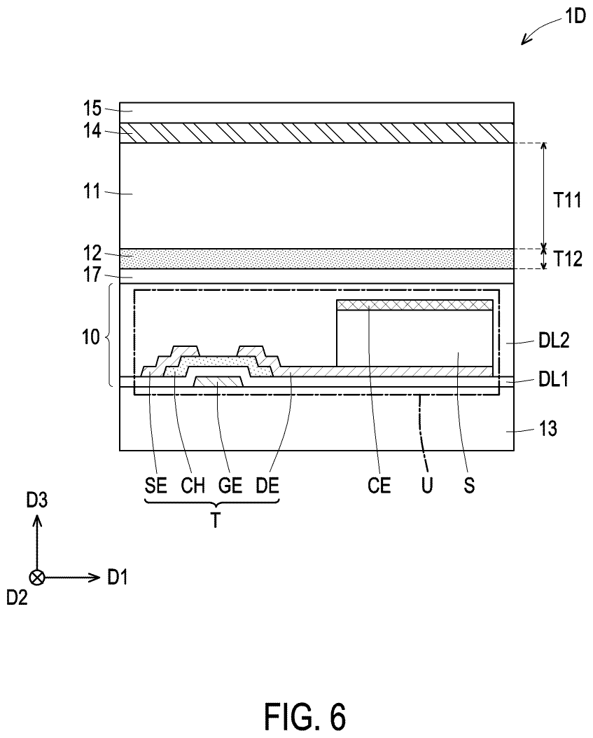

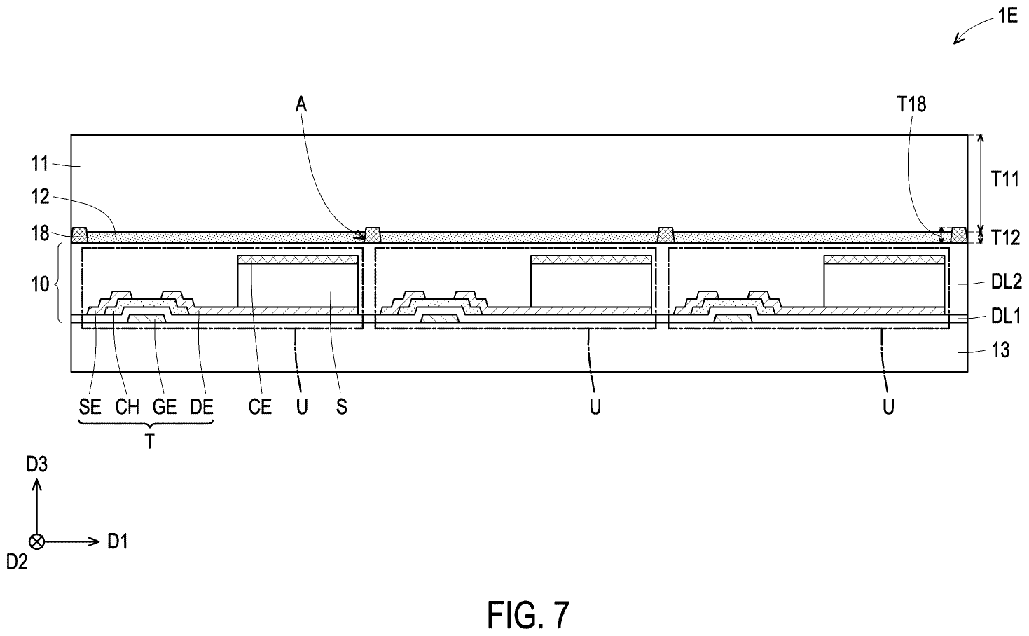

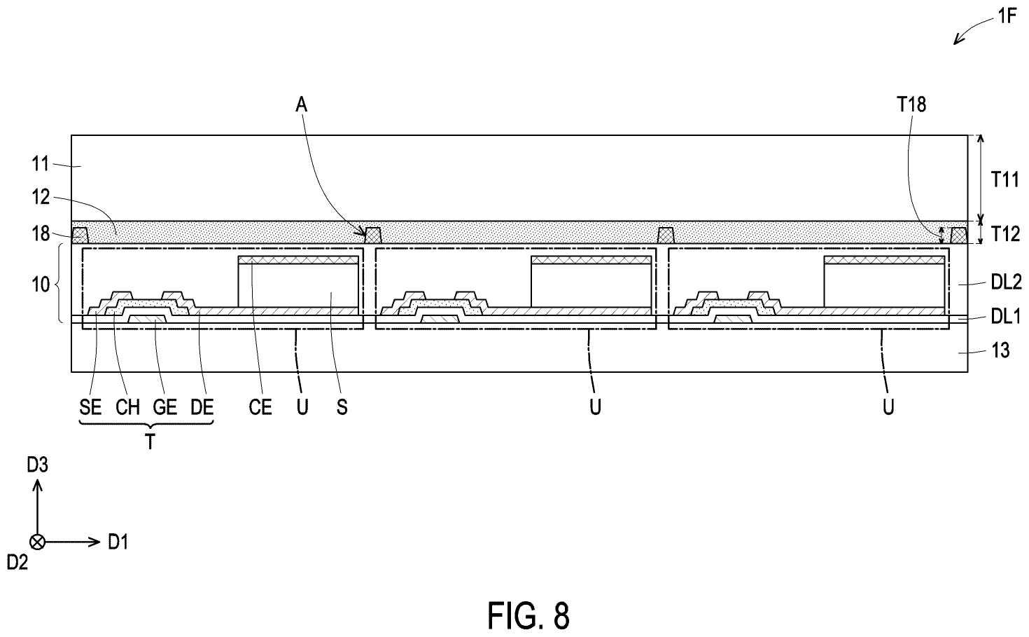

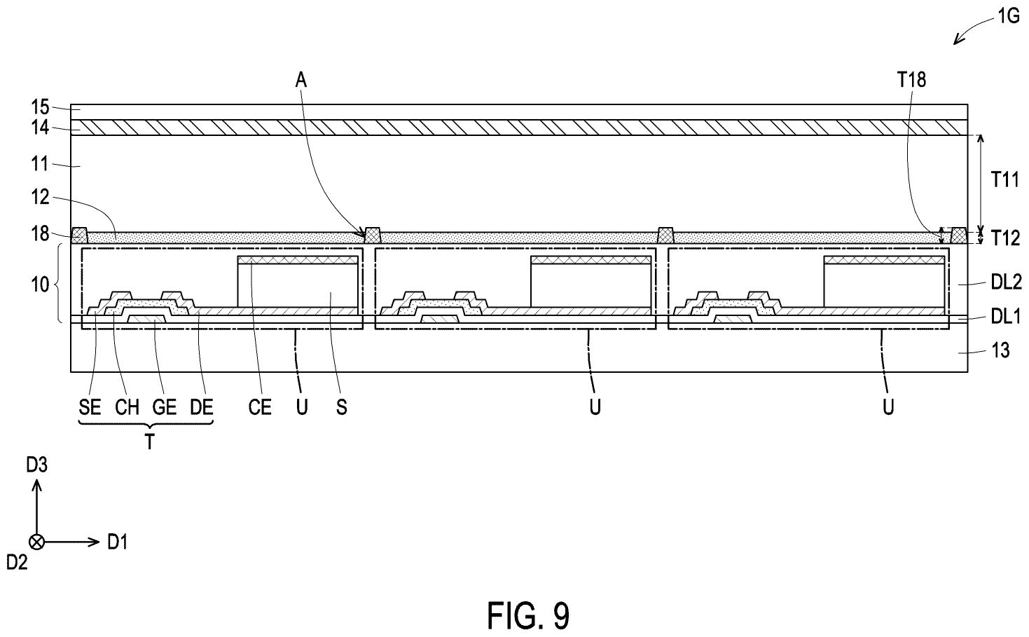

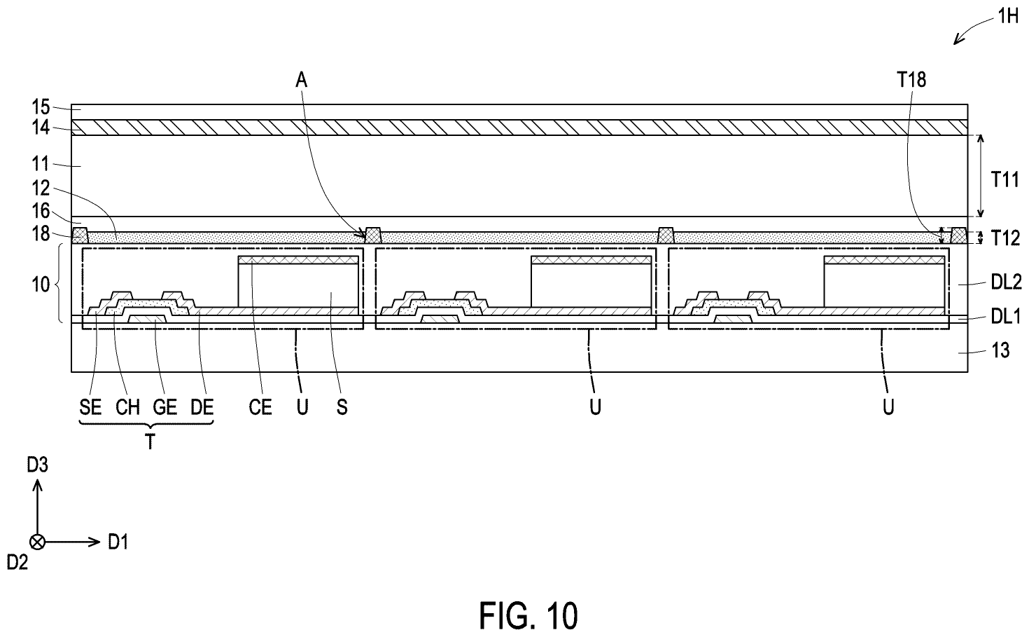

FIG. 1, FIG. 3, FIG. 4, FIG. 5, FIG. 6, FIG. 7, FIG. 8, FIG. 9, and FIG. 10 are respectively partial schematic cross-sectional diagrams of an electronic device according to some embodiments of the disclosure. FIG. 2 is a schematic diagram of an emission spectrum of a scintillator layer, an emission spectrum of a wavelength conversion layer, and an absorption response spectrum of a sensor.

Referring to FIG. 1 first, an electronic device 1 may include a sensor 10, a scintillator layer 11, and a wavelength conversion layer 12. The scintillator layer 11 is disposed on the sensor 10. The wavelength conversion layer 12 is disposed between the scintillator layer 11 and the sensor 10.

The scintillator layer 11 may be used to convert non-visible light (for example, an X-ray L) incident on the electronic device 1 into visible light (for example, a first visible light L1). In some embodiments, as shown in FIG. 2, the peak wavelength (for example, a first peak wavelength W11) of an emission spectrum S11 of the scintillator layer 11 is in the range of 350 nm to 520 nm. The first peak wavelength W11 is the wavelength at which the light intensity is maximum in the emission spectrum S11. In some embodiments, the material of the scintillator layer 11 includes a perovskite material, such as Cs₃Cu₂I₅, CsPbBr₃, MAPbI₃, MAPbBr₃, or other types of perovskite materials. In some embodiments, the scintillator layer 11 may be formed on the wavelength conversion layer 12 through a deposition process. The deposition process may include an evaporation process, but not limited thereto. In other embodiments, although not shown, the scintillator layer 11 may be attached to the wavelength conversion layer 12 through an adhesive layer. The adhesive layer may include an optical clear adhesive (OCA) or an optical clear resin (OCR), but not limited thereto.

The sensor 10 may be used to sense visible light (for example, the first visible light L1 and/or a second visible light L2) and generate an image corresponding to the light intensity distribution of the visible light. In some embodiments, as shown in FIG. 2, a peak wavelength W10 of an absorption response spectrum S10 of the sensor 10 is in the range of 500 nm to 700 nm. In other words, the sensor 10 has the best light conversion efficiency for visible light with a wavelength in the range of 500 nm to 700 nm.

In some embodiments, the sensor 10 may include a sensing unit U. The sensing unit U may include one or more switch elements T and one or more photosensitive elements S electrically connected to the one or more switch elements T. The switch element T may include, for example, a thin film transistor, an integrated circuit (IC), or other suitable switch elements. The photosensitive element S may include, for example, a photodiode, a phototransistor, a metal-semiconductor-metal photodetector (MSM photodetector), or other suitable photosensitive elements. FIG. 1 schematically illustrates that the sensing unit U includes a switch element T and a photosensitive element S, but it should be understood that the number of the switch element T and the photosensitive element S may be changed according to actual requirements.

In some embodiments, although not shown in FIG. 1, the sensor 10 may include a plurality of sensing units U, and the plurality of sensing units U may be arranged in an array along a direction D1 and a direction D2 to generate a two-dimensional image. The direction D1 and the direction D2 intersect each other and are both perpendicular to the thickness direction (for example, a direction D3) of the electronic device 1. In some embodiments, the direction D1 and the direction D2 are perpendicular to each other, but not limited thereto.

Taking FIG. 1 as an example, the electronic device 1 may further include a substrate 13 for carrying the sensor 10. The substrate 13 may be a hard substrate, a soft substrate, a curved substrate, a flexible substrate, or any type of substrate. In addition, the light transmittance of the substrate 13 is not limited, that is to say, the substrate 13 may be a light-transmitting substrate, a semi-light-transmitting substrate, or a non-light-transmitting substrate. For example, the material of the substrate 13 may include glass, quartz, sapphire, plastic, ceramics, stainless steel, polyimide (PI), polycarbonate (PC), polyethylene terephthalate (PET) or a combination of the above, but not limited thereto.

The sensor 10 is disposed on the substrate 13 and located, for example, between the substrate 13 and the scintillator layer 11. The sensor 10 may include a gate electrode GE, a dielectric layer DL1, a semiconductor pattern CH, a source electrode SE, a drain electrode DE, a photosensitive element S, a common electrode CE and a dielectric layer DL2, but not limited thereto. According to different requirements, the sensor 10 may add or remove one or more film layers.

The gate electrode GE is disposed on the substrate 13. The material of the gate electrode GE includes, for example, metal or a metal stack, such as aluminum, molybdenum, or titanium/aluminum/titanium, but not limited thereto.

The dielectric layer DLI is disposed on the substrate 13 and the gate electrode GE. The material of the dielectric layer DLI includes, for example, an organic insulating material, an inorganic insulating material, or a combination of the above. The organic insulating material includes, for example, polymethylmethacrylate (PMMA), epoxy, acrylic-based resin, silicone, polyimide polymer, or a combination of the above, but not limited thereto. The inorganic insulating material includes, for example, silicon oxide or silicon nitride, but not limited thereto.

The semiconductor pattern CH is disposed on the dielectric layer DL1 and overlaps the gate electrode GE in the direction D3. The material of the semiconductor pattern CH includes, for example, silicon semiconductor, oxide semiconductor, or other suitable semiconductor materials. The silicon semiconductor includes, for example, amorphous silicon or polycrystalline silicon. The oxide semiconductor includes, for example, indium tin oxide (ITO), indium zinc oxide (IZO), indium gallium oxide (IGO), or indium gallium zinc oxide (IGZO), but not limited thereto.

The source electrode SE and the drain electrode DE are disposed on the dielectric layer DL1, and the source electrode SE and the drain electrode DE are respectively located on two opposite sides of the semiconductor pattern CH. The materials of the source electrode SE and the drain electrode DE include, for example, metal or a metal stack, such as aluminum, molybdenum, or titanium/aluminum/titanium, but not limited thereto.

The photosensitive element S is located on the drain electrode DE. The material of the photosensitive element S includes, for example, silicon, germanium, indium gallium arsenide, lead sulfide, or other suitable semiconductor materials.

The common electrode CE is located on the photosensitive element S. The material of the common electrode CE may include a transparent conductive material. The transparent conductive material includes, for example, metal oxide, graphene, other suitable transparent conductive materials, or a combination of the above, but not limited thereto. The metal oxide includes, for example, indium tin oxide, indium zinc oxide, aluminum tin oxide, aluminum zinc oxide, indium germanium zinc oxide, or other metal oxides.

The dielectric layer DL2 is disposed on the dielectric layer DL1, the semiconductor pattern CH, the source electrode SE, the drain electrode DE, and the common electrode CE and surrounds the photosensitive element S. For the material of the dielectric layer DL2, reference may be made to the material of the dielectric layer DL1, which will not be repeated here.

In FIG. 1, the switch element T includes the gate electrode GE, the semiconductor pattern CH, the source electrode SE, and the drain electrode DE, and the photosensitive element S includes a photodiode. The photodiode may be a PN structure or a PIN structure. However, it should be understood that the type of the switch element T or the type of the photosensitive element S may be changed according to requirements and are not limited to those shown in FIG. 1.

The wavelength conversion layer 12 is used to convert visible light with a shorter wavelength (for example, the first visible light L1) from the scintillator layer 11 into visible light with a longer wavelength (for example, the second visible light L2) to reduce the difference between the peak wavelength of the visible light incident toward the sensor 10 and the peak wavelength W10 of the absorption response spectrum S10 of the sensor 10, so as to improve the light conversion efficiency of the sensor 10. In some embodiments, as shown in FIG. 2, the peak wavelength (for example, a second peak wavelength W12) of an emission spectrum S12 of the wavelength conversion layer 12 is in the range of 520 nm to 580 nm. The second peak wavelength W12 is the wavelength at which the light intensity is maximum in the emission spectrum S12. In some embodiments, the material of the wavelength conversion layer 12 includes a quantum dot, such as a quantum dot with a particle size of 2 nm to 8 nm and containing indium (In) and/or phosphorus (P), but not limited thereto. In other embodiments, the material of the wavelength conversion layer 12 includes an organic green phosphor material or an inorganic phosphor material, such as a solid solution (β-Sialon) of β-phase silicon nitride and oxide, but not limited thereto. In yet other embodiments, the material of wavelength conversion layer 12 includes a green fluorescent material. In some embodiments, the wavelength conversion layer 12 may be formed on the sensor 10 by coating. In other embodiments, although not shown, the wavelength conversion layer 12 may be attached to the sensor 10 through an adhesive layer. The adhesive layer may include an optical clear adhesive or an optical clear resin, but not limited thereto.

Referring to FIG. 1 and FIG. 2, in the electronic device 1, the scintillator layer 11 is used to convert the non-visible light (for example, the X-ray L) incident on the electronic device 1 into the first visible light L1 with the first peak wavelength W11, the wavelength conversion layer 12 is used to convert the first visible light Ll into the second visible light L2 with the second peak wavelength W12, and a difference DT1 between the peak wavelength W10 of the absorption response spectrum S10 of the sensor 10 and the first peak wavelength W11 is greater than a difference DT2 between the peak wavelength W10 of the absorption response spectrum S10 of the sensor 10 and the second peak wavelength W12. That is to say, the second peak wavelength W12 is closer to the peak wavelength W10 of the absorption response spectrum S10 of the sensor 10 than the first peak wavelength W11. Therefore, the light conversion efficiency of the sensor 10 for the second visible light L2 will be higher than the light conversion efficiency of the sensor 10 for the first visible light L1.

By disposing the wavelength conversion layer 12 between the sensor 10 and the scintillator layer 11 such that the wavelength conversion layer 12 is used to convert the first visible light L1 from the scintillator layer 11 into the second visible light L2 with higher light conversion efficiency for the sensor 10, the light conversion efficiency of the sensor 10 may be improved. Since the wavelength conversion layer 12 may be used to improve the problem of mismatch between the emission spectrum peak of the scintillator layer 11 and the absorption response spectrum peak of the sensor 10, the diversity of material selection for the scintillator layer 11 may be increased. For example, perovskite materials may be used, which have the advantages of relatively simple manufacturing process, low material cost, and/or good light conversion efficiency. Compared with modulating the material composition of the perovskite (for example, doping thallium (T1)) to reduce the difference between the emission spectrum peak of the scintillator layer 11 and the absorption response spectrum peak of the sensor 10, by disposing the wavelength conversion layer 12 to reduce the difference between the emission spectrum peak of the scintillator layer 11 and the absorption response spectrum peak of the sensor 10, the scintillator layer 11 may have better material stability and it is easier to modulate (for example, thicken) a thickness T11 of the scintillator layer 11.

In some embodiments, based on considerations such as the light conversion efficiency of the scintillator layer 11, process cost, process time, and/or the protection of the scintillator layer 11 for the sensor 10 (in reducing the probability of the X-ray L penetrating through the scintillator layer 11 and hitting the sensor 10), the thickness T11 of the scintillator layer 11 is in the range of 50 μm to 1000 μm. In some embodiments, based on considerations such as the conversion efficiency of the wavelength conversion layer 12, process cost, and/or process time, a thickness T12 of the wavelength conversion layer 12 is in the range of 2 μm to 40 μm. In some embodiments, the thickness T11 of the scintillator layer 11 is 1.25 times to 500 times the thickness T12 of the wavelength conversion layer 12.

Referring to FIG. 3, the main difference between an electronic device 1A and the electronic device 1 depicted in FIG. 1 lies in that the electronic device 1A further includes a reflective layer 14 disposed on the scintillator layer 11 and an encapsulation layer 15 disposed on the reflective layer 14. The reflective layer 14 may be used to reflect the visible light (for example, the first visible light L1 and/or the second visible light L2) transmitted away from the sensor 10 to help increase the light intensity of the visible light received by the sensor 10, so as to make the image much clearer. The reflective layer 14 may include a white reflective sheet or other film layers that may allow the X-ray L to penetrate through and may reflect the visible light. In some embodiments, the reflectivity of the reflective layer 14 for the visible light (for example, light with a wavelength in the range of 400 nm to 700 nm) is greater than 60%.

The encapsulation layer 15 may be used to reduce the adverse effects of the external environment (for example, light or moisture) on the underlying film layer (for example, the scintillator layer 11). The material of the encapsulation layer 15 may include aluminum or other water and oxygen-blocking materials that may allow the X-ray L to penetrate through. In other embodiments, although not shown, the encapsulation layer 15 may further cover the sidewalls of the reflective layer 14, the sidewalls of the scintillator layer 11, and/or the sidewalls of the wavelength conversion layer 12.

Referring to FIG. 4, the main difference between an electronic device 1B and the electronic device 1A depicted in FIG. 3 lies in that the electronic device 1B further includes an adhesive layer 16, and the scintillator layer 11 is attached to the wavelength conversion layer 12 through the adhesive layer 16. The adhesive layer 16 may include an optical clear adhesive or an optical clear resin, but not limited thereto.

Referring to FIG. 5, the main difference between an electronic device 1C and the electronic device 1B depicted in FIG. 4 lies in that the electronic device 1C further includes an adhesive layer 17, and the wavelength conversion layer 12 is attached to the sensor 10 through the adhesive layer 17. The adhesive layer 17 may include an optical clear adhesive or an optical clear resin, but not limited thereto.

Referring to FIG. 6, the main difference between an electronic device 1D and the electronic device 1C depicted in FIG. 5 lies in that the scintillator layer 11 in the electronic device 1D is formed on the wavelength conversion layer 12 by deposition, coating, or spraying, so the adhesive layer 16 may be omitted.

Referring to FIG. 7, the main differences between an electronic device 1E and the electronic device 1 depicted in FIG. 1 are described below. In the electronic device 1E, the plurality of sensing units U are, for example, arranged in an array along the direction D1 and the direction D2. Furthermore, the electronic device 1E also includes a spacer layer 18. The spacer layer 18 is disposed on the sensor 10 and includes a plurality of openings A. The plurality of openings A respectively overlap the plurality of photosensitive elements S of the sensor 10, and the wavelength conversion layer 12 is at least located in the plurality of openings A. The material of the spacer layer 18 may include a light-absorbing material or a light-reflecting material. When the spacer layer 18 is made of the light-absorbing material, the spacer layer 18 may be used to absorb stray light, thereby reducing light interference (crosstalk) between adjacent sensing units U or improving contrast. When the spacer layer 18 is made of the light-reflecting material, the spacer layer 18 may be used to improve light utilization (reflect the visible light incident on the spacer layer 18 to the photosensitive element S). The plurality of openings A of the spacer layer 18 are hollowed out portions of the spacer layer 18. The plurality of openings A respectively overlap the plurality of photosensitive elements S of the sensor 10, so that visible light may be transmitted to the plurality of photosensitive elements S through the plurality of openings A.

In some embodiments, a thickness T18 of the spacer layer 18 may be greater than the thickness T12 of the wavelength conversion layer 12. Under such an architecture, the wavelength conversion layer 12 may be disposed (for example, by coating or spraying) in the plurality of openings A, and the portion (for example, the bottom portion) of the scintillator layer 11 that contacts the wavelength conversion layer 12 may also be disposed in the plurality of openings A. In other embodiments, as shown in an electronic device IF depicted in FIG. 8, the thickness T12 of the wavelength conversion layer 12 may be greater than the thickness T18 of the spacer layer 18. Under such an architecture, the wavelength conversion layer 12 further covers the spacer layer 18, and the portion (for example, the bottom portion) of the scintillator layer 11 that contacts the wavelength conversion layer 12 is not disposed in the plurality of openings A.

Referring to FIG. 9, the main difference between an electronic device 1G and the electronic device 1E depicted in FIG. 7 lies in that the electronic device 1G further includes the reflective layer 14 disposed on the scintillator layer 11 and the encapsulation layer 15 disposed on the reflective layer 14.

Referring to FIG. 10, the main difference between an electronic device 1H and the electronic device 1G depicted in FIG. 9 lies in that the electronic device 1H further includes the adhesive layer 16, and the scintillator layer 11 is attached to the wavelength conversion layer 12 through the adhesive layer 16.

To sum up, in the embodiments of the disclosure, by disposing the wavelength conversion layer between the sensor and the scintillator layer such that the wavelength conversion layer is used to convert the first visible light from the scintillator layer into the second visible light with higher light conversion efficiency for the sensor, the light conversion efficiency of the sensor may be improved. Since the wavelength conversion layer may be used to improve the problem of mismatch between the emission spectrum peak of the scintillator layer and the absorption response spectrum peak of the sensor, the diversity of material selection for the scintillator layer may be improved. Compared with modulating the material composition of the scintillator layer, by disposing the wavelength conversion layer to reduce the difference between the emission spectrum peak of the scintillator layer and the absorption response spectrum peak of the sensor, the scintillator layer may have better material stability and it is easier to modulate (for example, thicken) the thickness of the scintillator layer.

The above embodiments are only used to illustrate, but not to limit, the technical solutions of the disclosure. Although the disclosure has been described in detail with reference to the above embodiments, persons skilled in the art should understand that the technical solutions described in the above embodiments may still be modified or some or all of the technical features thereof may be equivalently replaced. However, the modifications or replacements do not cause the essence of the corresponding technical solutions to deviate from the scope of the technical solutions of the embodiments of the disclosure.

Although the embodiments and the advantages of the disclosure have been disclosed above, it should be understood that any person skilled in the art may make changes, substitutions, and modifications without departing from the spirit and scope of the disclosure, and the features of the embodiments may be arbitrarily mixed and replaced to form other new embodiments. In addition, the protection scope of the disclosure is not limited to processes, machines, manufactures, material compositions, devices, methods, and steps in the specific embodiments described in the specification. Any person skilled in the art may understand conventional or future-developed processes, machines, manufactures, material compositions, devices, methods, and steps from the content of the disclosure as long as the same may implement substantially the same functions or obtain substantially the same results as the embodiments described herein when used according to the disclosure. Therefore, the protection scope of the disclosure includes the above processes, machines, manufactures, material compositions, devices, methods, and steps. In addition, each claim constitutes a separate embodiment, and the protection scope of the disclosure also includes combinations of the claims and the embodiments. The protection scope of the disclosure should be defined by the appended claims.

What is claimed is:

1. An electronic device, comprising:
a sensor;
a scintillator layer, disposed on the sensor; and
a wavelength conversion layer, disposed between the scintillator layer and the sensor.

2. The electronic device according to claim 1, wherein a peak wavelength of an emission spectrum of the scintillator layer is in a range of 350 nm to 520 nm.

3. The electronic device according to claim 1, wherein a material of the scintillator layer comprises a perovskite material.

4. The electronic device according to claim 1, wherein a peak wavelength of an emission spectrum of the wavelength conversion layer is in a range of 520 nm to 580 nm.

5. The electronic device according to claim 1, wherein a peak wavelength of an absorption response spectrum of the sensor is in a range of 500 nm to 700 nm.

6. The electronic device according to claim 1, wherein the scintillator layer is configured to convert non-visible light incident on the electronic device into a first visible light with a first peak wavelength, the wavelength conversion layer is configured to convert the first visible light into a second visible light with a second peak wavelength, and a difference between a peak wavelength of an absorption response spectrum of the sensor and the first peak wavelength is greater than a difference between the peak wavelength of the absorption response spectrum of the sensor and the second peak wavelength.

7. The electronic device according to claim 6, wherein the second peak wavelength is between the first peak wavelength and the peak wavelength of the absorption response spectrum of the sensor.

8. The electronic device according to claim 1, wherein a thickness of the scintillator layer is 1.25 to 500 times a thickness of the wavelength conversion layer.

9. The electronic device according to claim 1, wherein a thickness of the scintillator layer is in a range of 50 μm to 1000 μm.

10. The electronic device according to claim 1, wherein a thickness of the wavelength conversion layer is in a range of 2 μm to 40 μm.

11. The electronic device according to claim 1, further comprising:
a reflective layer, disposed on the scintillator layer; and
an encapsulation layer, disposed on the reflective layer.

12. The electronic device according to claim 11, wherein the reflective layer allows an X-ray to penetrate through and reflects visible light.

13. The electronic device according to claim 1, further comprising:
a spacer layer, disposed on the sensor, and comprising a plurality of openings, wherein the plurality of openings respectively overlap a plurality of photosensitive elements of the sensor, and the wavelength conversion layer is located at least in the plurality of openings.

14. The electronic device according to claim 13, wherein a material of the spacer layer comprises a light-absorbing material or a light-reflecting material.

15. The electronic device according to claim 13, wherein a thickness of the spacer layer is greater than a thickness of the wavelength conversion layer.

16. The electronic device according to claim 15, further comprising:
an adhesive layer, wherein the scintillator layer is attached to the wavelength conversion layer through the adhesive layer, and at least a portion of the adhesive layer is located in the plurality of openings.

17. The electronic device according to claim 13, wherein a thickness of the wavelength conversion layer is greater than a thickness of the spacer layer, and a portion of the scintillator layer that contacts the wavelength conversion layer is not disposed in the plurality of openings.

18. The electronic device according to claim 1, further comprising:
an adhesive layer, wherein the scintillator layer is attached to the wavelength conversion layer through the adhesive layer.

19. The electronic device according to claim 1, further comprising:
an adhesive layer, wherein the wavelength conversion layer is attached to the sensor through the adhesive layer.

20. The electronic device according to claim 1, further comprising:
a first adhesive layer, wherein the wavelength conversion layer is attached to the sensor through the first adhesive layer, and
a second adhesive layer, wherein the scintillator layer is attached to the wavelength conversion layer through the second adhesive layer.
